(19) United States
(12) Patent Application Publication
(10) Pub. No.: US 2015/0143987 A1
(43) Pub. Date: May 28, 2015

(54) COMBINED HYDRAULIC/PNEUMATIC ACTUATION SYSTEM WITH INTERNAL PNEUMATIC PISTON

(71) Applicant: Eaton Corporation, Cleveland, OH (US)

(72) Inventors: Daniel Henry Roberts, Monrovia, CA (US); Sarkis Isayan, Glendale, CA (US)

(73) Assignee: Eaton Corporation, Cleveland, OH (US)

(21) Appl. No.: 14/397,261

(22) PCT Filed: Mar. 14, 2013
(86) PCT No.: PCT/US2013/031446

§ 371 Date: Oct. 27, 2014

Related U.S. Application Data
(60) Provisional application No. 61/640,498, filed on Apr. 30, 2012.

(51) Int. Cl. F15B 11/076; F15B 15/22

(52) U.S. Cl. CPC F15B 11/076; F15B 15/22; F15B 2211/405; F15B 2211/47
USPC 91/4 R

(57) ABSTRACT

A combined hydraulic and pneumatic actuation system including a cylinder, a first piston, and a second piston. The cylinder may include a first cylinder portion configured to hold or retain a first fluid and a second cylinder portion configured to hold or retain a second fluid. The first piston can be operatively coupled or in fluid communication with the first fluid, and the second piston can be operatively coupled or in fluid communication with the second fluid. The second piston may be disposed between the first cylinder portion and the second cylinder portion. In an embodiment, the first piston can move or translate axially within the cylinder independently of the second piston, and an increase in pressure in the second cylinder portion can actuate the first piston and the second piston. Further, in embodiments, the first fluid can comprise a liquid, and the second fluid can comprise a gas.

### CROSS-REFERENCE TO RELATED APPLICATIONS

This application is a national stage filing based upon International Application No. PCT/US2013/031446, with an international filing date of Mar. 14, 2013, which claims the benefit of U.S. Provisional Application Ser. No. 61/640,498, filed Apr. 30, 2012, the disclosure of which is incorporated herein by reference in its entirety.

### TECHNICAL FIELD

The present disclosure relates to actuation systems, including combined hydraulic and pneumatic actuators.

### BACKGROUND

Hydraulic actuators are used in a number of applications in modern aircraft including, for example, for opening and closing passenger doors. In aircraft doors, the hydraulic actuator is generally used for damping—i.e., for slowing the movement of the aircraft door when the door is opened or closed manually. Such hydraulic damping systems are typically accompanied by a backup actuation system for emergency use, or for when manual operation of the door is otherwise not possible or may be undesirable. The backup actuation system in many known systems is pneumatic. As a result, conventional aircraft doors are commonly equipped with separate hydraulic and pneumatic actuation systems.

Several types of combined hydraulic and pneumatic actuation systems are known in the art. In a first known combined system, the pneumatic system and the hydraulic system may have totally separate cylinders coupled to the door. Such systems can add additional weight to the aircraft. In a second known combined system, the pneumatic system may include an entire cylinder that is disposed within the hydraulic cylinder. Though such a second known combined system may reduce the associated weight, it may still add a less than desirable amount of weight to the aircraft. In a third known combined system, the pneumatic system may be configured to inject air into the hydraulic cylinder. Such a system generally requires that the hydraulic cylinder be bled after using the pneumatic backup, which can also be undesirable.

The present disclosure seeks to address one or more of the above-identified challenges.

### SUMMARY

An actuation system is disclosed that includes a cylinder, a first piston, and a second piston. The cylinder may have a first cylinder portion for holding or retaining a first fluid, and a second cylinder portion for holding or retaining a second fluid. The first piston can be operatively coupled or in fluid communication with the first fluid, and the second piston can operatively coupled or in fluid communication with the second fluid. The second piston can be disposed between the first cylinder portion and the second cylinder portion. The addition or removal of second fluid with respect to the second cylinder portion may actuate the first piston and the second piston. In an embodiment, the cylinder may further include a third cylinder portion and the first piston may be disposed between the first cylinder portion and the third cylinder portion. In an embodiment, and without limitation, the first fluid may comprise a liquid, and the second fluid may comprise a gas.

Embodiments of the system may include an actuator that comprises a cylinder having an anterior end (or anterior portion) and a posterior end (or posterior portion), and a piston rod that extends from within the cylinder through the anterior end/portion of the cylinder. The actuator can further comprise a first piston disposed within the cylinder, and a second piston disposed within the cylinder, and may be configured to apply an anterior force to the first piston and the piston rod in response to an increase in fluid pressure in a portion of the cylinder.

In an embodiment, a combined hydraulic and pneumatic actuator can comprise a cylinder having a barrel, a hydraulic piston disposed within the cylinder and abutting the cylinder barrel, coupled to a piston rod, and a pneumatic piston, disposed within the cylinder and abutting the cylinder barrel.

Various aspects of the present disclosure will become apparent to those skilled in the art from the following detailed description of the embodiments, when read in light of the accompanying drawings.

### BRIEF DESCRIPTION OF THE DRAWINGS

Embodiments of the invention will now be described, by way of example, with reference to the accompanying drawings, wherein:

FIG. 1 is a diagrammatic cross-sectional view of a combined hydraulic and pneumatic actuation system in accordance with an embodiment of the present disclosure.

FIG. 2 is a diagrammatic cross-sectional view of the combined hydraulic and pneumatic actuation system of the type illustrated in FIG. 1, in a first actuation state.

FIG. 3 is a diagrammatic cross-sectional view of the combined hydraulic and pneumatic actuation system of the type illustrated in FIG. 1 and FIG. 2, shown in a second actuation state.

### DETAILED DESCRIPTION

Reference will now be made in detail with respect to embodiments of the present disclosure, examples of which are described herein and illustrated in the accompanying drawings. While concepts will be described in conjunction with embodiments, it will be understood that the invention is not intended to limit the specific disclosures associated with the embodiments. On the contrary, the invention is intended to cover alternatives, modifications and equivalents, which may be included within the spirit and scope of the invention as defined by the appended claims.

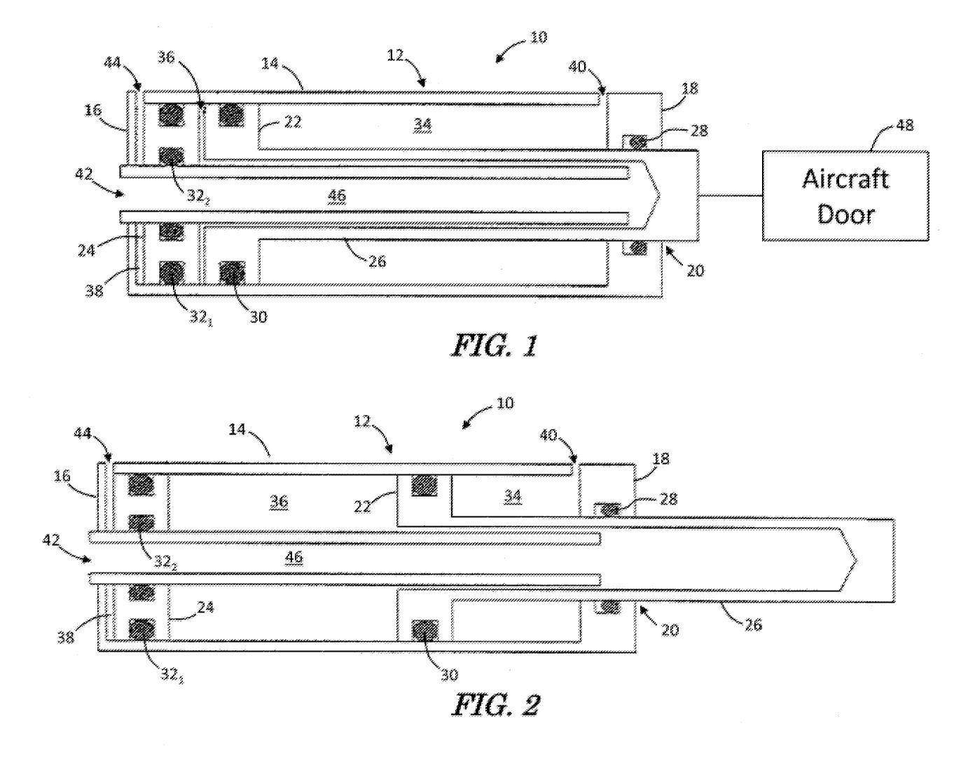

FIG. 1 is a diagrammatic cross-sectional view of an embodiment of a combined hydraulic and pneumatic actuation system 10. The system 10 can include a cylinder 12 having a barrel 14, a base 16, a head 18 and a rod gland 20, an anterior piston 22, a posterior piston 24, a piston rod 26. The system may also include an anterior seal 28, a middle seal 30, and a pair of posterior seals 32₁, 32₂. The cylinder 12 may also include an anterior cylinder portion 34, a middle cylinder portion 36, and a posterior cylinder portion 38. Each of the cylinder portions may include a respective fluid inlet 40, 42, 44. The combined system may also include a transfer tube, such as illustrated transfer tube 46. The combined system 10 may be coupled to an apparatus to be actuated, such as an aircraft door 48.

The piston rod 26 can be connected or coupled to an apparatus to be actuated, as is known in the art. For example, in an embodiment a piston rod, such as illustrated piston rod 26, may be connected or coupled to the aircraft door 48 on one end and to an anterior (or “first”) piston 22 on the other end. In an embodiment, a combined system may be configured such that an anterior movement of the piston rod 26 will open the aircraft door 48, and a posterior movement of the piston rod 26 will close the aircraft door 48. Similarly, with embodiments, a manual opening of the aircraft door 48 may move the piston rod 26 in an anterior direction, and a manual closing of the aircraft door 48 may move the piston rod 26 in a posterior direction. Of course, the combined actuation system 10 is not limited to use in aircraft or with aircraft doors. A wide range of applications is both possible and will be contemplated.

In embodiments, the anterior piston 22 can be configured to operate as part of a hydraulic actuation system. Accordingly, the anterior and middle cylinder portions 34, 36 can be configured to receive, for example, liquid hydraulic fluid through anterior and middle fluid inlets 40, 42. An increase in fluid pressure in the anterior cylinder portion 34 can apply a posterior force to the anterior piston 22, and an increase in fluid pressure in the middle cylinder portion 36 can apply an anterior force to the anterior piston 22.

In embodiments, transfer tube 46 can be configured to direct or route fluid from the middle fluid inlet 42 to the middle cylinder portion 36. The transfer tube 46 may extend through posterior and anterior pistons 22, 24 (e.g., through the centers of the posterior and anterior pistons 22, 24), and may extend through a portion of the piston rod 26. To accommodate the transfer tube 46, the piston rod 26 can have a hollow center that may be configured to receive the same fluid as the middle cylinder portion 36.

Further, embodiments of a system may be configured to act or serve as a damper with respect to manual movement of the piston rod 26 (e.g., during manual operation of the apparatus to which the piston rod 26 is coupled, such as the aircraft door 48). In embodiments, when the piston rod 26 is manually moved in an anterior direction, the fluid in the anterior cylinder portion 34 may damp the anterior movement of the anterior piston 22, and thus slow the movement of the piston rod 26 and an apparatus to which the piston rod 26 may be attached or connected, whether directly or indirectly. Similarly, when the piston rod 26 is manually moved in a posterior direction, the fluid in the middle cylinder portion 36 may damp the posterior movement of the anterior piston 22, and thus slow the movement of the piston rod 26 and an apparatus to which the piston rod 26 may be attached or connected.

In embodiments, posterior (or “second”) piston 24 can be configured to operate as part of a pneumatic actuation system. Accordingly, the posterior cylinder portion 38 can be configured to receive a medium, for example, a gaseous fluid through a posterior fluid inlet 44. An increase in the fluid pressure in the posterior cylinder portion 38 can apply an anterior force to the posterior piston 24. In turn, the posterior piston 24 can transfer that anterior force to the anterior piston 22 such that the anterior and posterior pistons 22, 24, and the piston rod 26 experience an anterior force.

Because the anterior piston 22 can move or translate axially within the cylinder 12 substantially independently of the posterior piston 24, with the posterior piston 24 disposed at the posterior end of the cylinder 12, the anterior piston 22 can serve as part of a primary actuation or damping system associated with the piston rod 26. And because the posterior piston 24 can apply a force to the anterior piston 22 (and thus to the piston rod 26), the posterior piston 24 can serve as part of a secondary actuation system. For example, in embodiments, the anterior piston 22 may be solely or primarily utilized in connection with the normal operation of an apparatus to which the actuation system 10 is coupled or connected (such as an aircraft door, for example only). The posterior piston 24 could then, for example, be available for or only secondarily utilized in emergency conditions or for other secondary operation of the associated apparatus.

As used herein “anterior cylinder portion,” “middle cylinder portion,” and “posterior cylinder portion” refer to relative portions of the cylinder 12, not discrete portions. The anterior cylinder portion 34 may comprise a portion of the cylinder between the anterior piston 22 and the cylinder head 18; the middle cylinder portion 36 may comprise a portion of the cylinder 12 between the anterior piston 22 and the posterior piston 24; and the posterior cylinder portion 38 may comprise a portion of the cylinder 12 between the posterior piston 24 and the cylinder base 16.

Embodiments of the system may include a plurality of associated seals. In embodiments, anterior, middle, and posterior seals 28, 30, 32 may be provided to prevent a medium (such as fluids) in the anterior, middle, and posterior cylinder portions 34, 36, 38 from mixing by passing the anterior and posterior pistons 22, 24 into other cylinder portions, and also from escaping the cylinder 12. Seals 28, 30, 32 are illustrated as annular seals with substantially circular cross-sections. However, the system is not so limited, and such seals may be of any suitable shape, material, and type known in the art for hydraulic, pneumatic, and similar actuation systems.

Although the system 10 is described herein in terms of a hydraulic actuation system and a pneumatic actuation system, the system 10 is not so limited. Other types of actuation systems are possible and contemplated. Furthermore, though the cylinder portions 34, 36, 38 are described with respect to specific mediums or fluids (i.e., hydraulic fluid in the anterior and middle cylinder portions 34, 36 and gas in the posterior cylinder portion 38), the system 10 is, once again, not so limited. The types of fluids used to actuate the anterior and posterior pistons 22, 24 may be selected based on the structural or operational needs of a particular application.

FIG. 2 is a diagrammatic cross-sectional view of a combined hydraulic and pneumatic actuation system 10 shown in a first actuation state. In the illustrated actuation state, the anterior piston 22 and the piston rod 26 are shown translated in an anterior direction (as compared with FIG. 1). As generally illustrated, the piston rod 26 extends farther through the rod gland 20 than as depicted in FIG. 1. Such movement can be the result of an increase in fluid pressure in the middle cylinder portion 36—which may be provided through the middle fluid inlet 42 and the transfer tube 46. In such a first actuation state, the posterior piston 24 may remain substantially at the posterior end of the cylinder 12.

The movement of the piston rod 26 and anterior piston 22 illustrated in FIG. 2 could also be the product of manual actuation of the piston rod 26. As the piston rod 26 is manually moved in the anterior direction, the anterior piston 22 may also move in the anterior direction, and the fluid in the anterior cylinder portion 34 can serve to damp the movement. Similarly, when the piston rod 26 is moved in the posterior direction, the fluid in the middle cylinder portion 36 can serve to damp the movement of the anterior piston 22. Such damping may find use in, for example only, an aircraft door application.

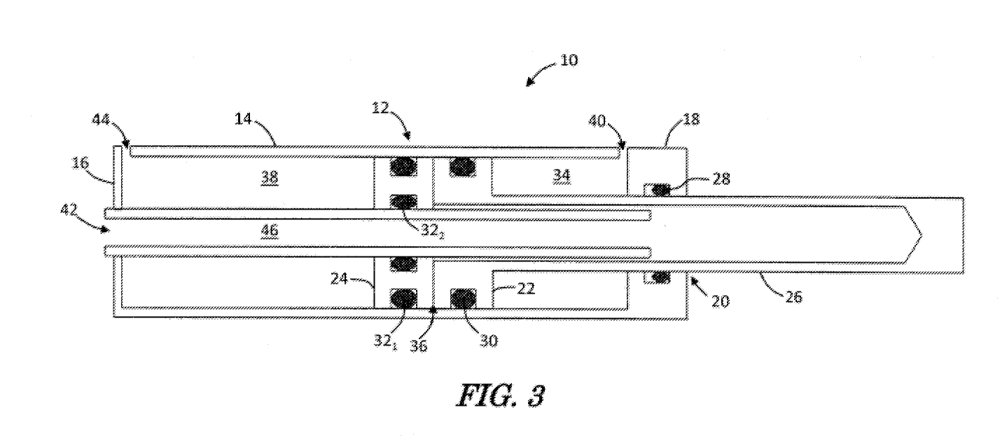

FIG. 3 is a diagrammatic cross-sectional view of a combined hydraulic and pneumatic actuation system 10, such as generally illustrated in FIGS. 1 and 2, shown in a second actuation state. In the illustrated actuation state, the posterior piston 24, anterior piston 22, and piston rod 26 are all shown as having translated or moved in an anterior direction. The piston rod 26 extends through the rod gland 20, and extends comparatively further than as depicted in FIG. 1. Such a movement can be the result of an increase in fluid pressure in the posterior cylinder portion 38. Such an increase in pressure can apply an anterior force to the posterior piston 24, which in turn can apply an anterior force to the anterior piston 22, and further to the piston rod 26.

In an embodiment, the piston rod 26 can be coupled to an aircraft door. The door can be configured to open and close manually in normal operation. During manual operation, the anterior piston 22 and the fluid in the anterior and middle cylinder portions 34, 36 can serve to damp the movement of the piston rod 26, and thus damp the movement of the door. When manual operation of the door is not possible or otherwise undesirable, such as during an emergency, the posterior piston 24 could be utilized or actuated to open the door. For example, the posterior piston could be configured to be actuated by increasing the fluid pressure in the posterior cylinder portion 38, such as generally represented in FIG. 3. By way of example, and without limitation, in embodiments, the fluid in the anterior and middle cylinder portions 34, 36 can comprise a liquid (e.g., hydraulic fluid), and the fluid in the posterior cylinder portion 38 can comprise a gas.

The drawings are intended to illustrate various concepts associated with the disclosure and are not intended to limit the claims. A wide range of changes and modifications to the embodiments described above will be apparent to those skilled in the art, and are contemplated. It is therefore intended that the foregoing detailed description be regarded as illustrative rather than limiting, and that it be understood that the following claims, including all equivalents, are intended to define the spirit and scope of this invention.

What is claimed:

1. An actuation system comprising:
a cylinder having a first cylinder portion configured to hold or retain a first fluid, and a second cylinder portion configured to hold or retain a second fluid;
a first piston operatively coupled or in fluid communication with the first fluid; and
a second piston operatively coupled or in fluid communication with the second fluid, the second piston disposed between the first cylinder portion and the second cylinder portion;
wherein the first piston can move or translate axially within the cylinder independently of the second piston, and an increase in pressure in the second cylinder portion actuates the first piston and the second piston.

2. The actuation system of claim 1, wherein the cylinder further comprises a third cylinder portion, further wherein the first piston is disposed between the first cylinder portion and the third cylinder portion.

3. The actuation system of claim 2, wherein the first cylinder portion, the second cylinder portion, and the third cylinder portion each have a respective fluid inlet.

4. The actuation system of claim 2, wherein the third cylinder portion is configured to receive the first fluid.

5. The actuation system of claim 1, further comprising a piston rod connected or coupled to the first piston.

6. The actuation system of claim 5, wherein the piston rod is connected to an aircraft door.

7. The actuation system of claim 1, wherein the first fluid comprises a liquid.

8. The actuation system of claim 1, wherein the second fluid comprises a gas.

9. The actuation system of claim 1, further comprising one or more seals configured to prevent mixture of the first fluid and the second fluid.

10. An actuator comprising:
a cylinder having an anterior end and a posterior end;
a piston rod partially disposed within the cylinder such that an anterior end of the piston rod extends from the anterior end of the cylinder;
a first piston disposed within the cylinder; and
a second piston disposed within the cylinder;
wherein the second piston is configured to apply an anterior force to the first piston and the piston rod in response to an increase in fluid pressure in a portion of the cylinder.

11. The actuator of claim 10, wherein the cylinder is configured to receive a first fluid and a second fluid.

12. The actuator of claim 10, wherein the cylinder includes three cylinder portions, separated by the first piston and the second piston.

13. The actuator of claim 10, wherein the first piston is configured to dampen movement of the piston rod.

14. The actuator of claim 10, wherein the second piston is disposed within the cylinder posterior to the first piston.

15. The actuator of claim 10, wherein the first piston is connected or coupled to the piston rod.

16. A combined hydraulic and pneumatic actuator comprising:
a cylinder having a barrel;
a hydraulic piston, disposed within the cylinder and abutting the cylinder barrel, the hydraulic piston connected or coupled to a piston rod; and
a pneumatic piston, disposed within the cylinder and abutting the cylinder barrel.

17. The actuator of claim 16, wherein the cylinder comprises a hydraulic fluid inlet and a pneumatic gas inlet.

18. The actuator of claim 16, wherein the cylinder comprises a head through which the piston rod extends, and the hydraulic piston is disposed closer to the cylinder head than the pneumatic piston.

19. The actuator of claim 16, wherein the hydraulic piston and the pneumatic piston have substantially the same diameter.

20. The actuator of claim 16, wherein the hydraulic piston is configured to actuate independent of the pneumatic piston during normal operation.
